(19) United States
(12) Patent Application Publication
(10) Pub. No.: US 2019/0179586 A1
(43) Pub. Date: Jun. 13, 2019

(54) DISPLAY DEVICE AND METHOD FOR CONTROLLING THE SAME

(71) Applicant: BOE TECHNOLOGY GROUP CO., LTD., Beijing (CN)

(72) Inventors: Yuanyuan LI, Beijing (CN); Meizhu ZHENG, Beijing (CN); Lina LIU, Beijing (CN)

(21) Appl. No.: 16/051,589

(22) Filed: Aug. 1, 2018

(30) Foreign Application Priority Data
Dec. 8, 2017 (CN) 201711295345.4

(51) Int. Cl. G06F 3/14; G06F 3/0488; G06K 9/00

(52) U.S. Cl. CPC G06F 3/1423; G06K 9/00255; G06K 9/00013; G06F 3/04886

(57) ABSTRACT

The present disclosure provides a display device and a method for controlling the same, which belong to the field of display technology. The display device includes a housing which is provided thereon with a first display component, an auxiliary display component and a second display component that are connected in sequence, and the first display component and the second display component are oppositely disposed.

### CROSS REFERENCE

The present application is based upon and claims priority to Chinese Patent Application No. 201711295345.4, entitled “DISPLAY DEVICE AND METHOD FOR CONTROLLING THE SAME” and filed on Dec. 8, 2017, and the entire contents thereof are incorporated herein by reference.

### TECHNICAL FIELD

The present disclosure relates to the field of display technology, in particular, to a display device and method for controlling the same.

### BACKGROUND

With the development of science and technology, the operation frequency of display devices is getting higher and higher, and people have higher and higher requirements for the display area of display devices.

### SUMMARY

The present application provides a display device and method for controlling the same, and the implementations are as follows.

According to one aspect, the present disclosure provides a display device including a housing,

wherein the housing is provided thereon with a first display component, an auxiliary display component and a second display component that are connected in sequence, and the first display component and the second display component are oppositely disposed.

Optionally, the first display component, the auxiliary display component, and the second display component are connected into an integrated piece, and each of the first display component, the auxiliary display component, and the second display component is formed of flexible material.

Optionally, a display area of the first display component is greater than a display area of the second display component.

Optionally, at least one of the first display component, the auxiliary display component, and the second display component has a touch function.

Optionally, at least one of the first display component, the auxiliary display component, and the second display component has a fingerprint recognition function.

Optionally, the display device further includes a first cover covering the first display component and the auxiliary display component and a second cover covering the second display component.

Optionally, the display device further includes a first image capturing component, a second image capturing component and a face recognition component, wherein the first image capturing component and the second image capturing component are both connected to the face recognition component, and

the first image capturing component is disposed adjacent to the first display component, the second image capturing component is disposed adjacent to the second display component, and an image capturing side of the first image capturing component is a display side of the first display component, and an image capturing side of the second image capturing component is a display side of the second display component.

Optionally, the display device further includes a fill light disposed adjacent to the second display component, and

a light emitting side of the fill light is the display side of the second display component.

According to another aspect, the present disclosure provides a method for controlling a display device applicable in a control device of the above display device, the method including:

controlling at least one of the first display component, the auxiliary display component, and the second display component to perform a display operation.

Optionally, the controlling at least one of the first display component, the auxiliary display component, and the second display component to perform a display operation includes:

capturing a first image using the first image capturing component;

capturing a second image using the second image capturing component;

recognizing whether a face image is included in the first image and the second image using the face recognition component;

controlling the first display component to perform the display operation in the case where the first image includes the face image; and

controlling the second display component to perform the display operation in the case where the second image includes the face image.

According to a further aspect, the present disclosure provides a control device for a display device, wherein the control device includes:

a first capturing module, configured to control a first image capturing component to capture a first image;

a second capturing module, configured to control a second image capturing component to capture a second image;

a recognition module, configured to recognize whether a face image is included in the first image and the second image;

a first display module, configured to control a first display component to perform a display operation in the case where the first image includes the face image; and

a second display module, configured to control a second display component to perform a display operation in the case where the second image includes the face image.

It is to be understood that both the foregoing general description and the following detailed description are exemplary and explanatory only and are not intended to limit the present disclosure.

### BRIEF DESCRIPTION OF THE DRAWINGS

In order to more clearly illustrate the embodiments of the present disclosure, drawings required for illustrating the embodiments of the present disclosure will be briefly described below. It will be apparent that the drawings in the following description refer only to some embodiments of the present disclosure, and from the drawings other drawings are available to those of ordinary skill in the art without creative work.

FIG. 1 is a front view of a display device according to an embodiment of the present disclosure;

FIG. 2 is a rear view of a display device according to an embodiment of the present disclosure;

FIG. 3 is an exploded structural view of a display screen according to an embodiment of the present disclosure;

FIG. 4 is a front view of another display device according to an embodiment of the present disclosure;

FIG. 5 is a method flowchart of a method for controlling a display device according to an embodiment of the present disclosure;

FIG. 6 is an interface displayed in a second display component according to an embodiment of the present disclosure; and

FIG. 7 is a structural view of a control device of a display device according to an embodiment of the present disclosure.

### DETAILED DESCRIPTION

In order to make the objectives, technical solutions and advantages of the embodiments of the present disclosure more clear, the technical solutions of the embodiments of the present disclosure will be described clearly and completely in conjunction with the accompanying drawings of the embodiments of the present disclosure. It is obvious that the described embodiments are part of the embodiments rather than all embodiments of the present disclosure. All other embodiments obtained by one of ordinary skill in the art based on the described embodiments of the present disclosure without the need for creative work are within the scope of the present disclosure.

With the development of science and technology, the operation frequency of display devices is getting higher and higher, and people have higher and higher requirements for the display area of display devices. In the related art, the display area of the display device is generally increased by reducing the area of the bezel of the display device and increasing the area of the display region of the display screen. Since devices such as a receiver, a loudspeaker, a camera and the like, which have a certain size, are generally required to be disposed in the bezel of the display device, the reduction in the area of the bezel of the display device and the increase in the area of the display screen are limited, resulting in a small display area of the display device.

Embodiments of the present disclosure provide a display device having a relative larger display area.

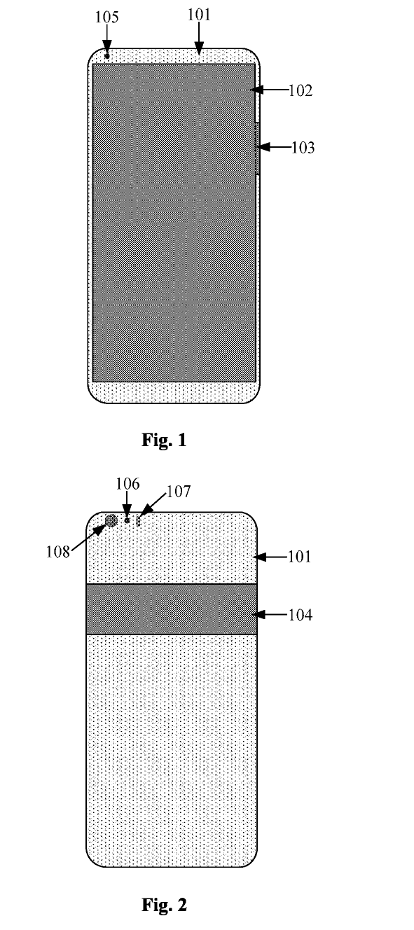

FIG. 1 is a front view of a display device according to an embodiment of the present disclosure; and FIG. 2 is a rear view of a display device according to an embodiment of the present disclosure. Referring to FIGS. 1 and 2, the display device includes a housing 101 which is provided with thereon with a first display component 102, an auxiliary display component 103 and a second display component 104 that are connected in sequence, wherein the first display component 102 and the second display component 104 are oppositely disposed.

In summary, in the display device according to the embodiment of the present disclosure, since the housing is provided with the first display component, the auxiliary display component and the second display component that are connected in sequence and the first display component and the second display component are oppositely disposed, the display region is provided on each of a front side, a rear side and a side edge of the display device, thereby increasing the display area of the display device.

It should be noted that in the display device according to the embodiment of the present disclosure, each display component may be embedded into the housing of the display device to improve the smoothness of the appearance of the display device.

The display device shown in FIGS. 1 and 2 is exemplified by the auxiliary display component 103 disposed on the right edge of the housing 101. In practical applications, the auxiliary display component 103 may alternatively be disposed at other side edges of the housing 101 (e.g., a left side edge, an upper side edge, or a lower side edge). In addition, the display device shown in FIGS. 1 and 2 is exemplified that the first display component 102 and the second display component 104 are flat display components, and the auxiliary display component 103 is a curved display component. In practical applications, the first display component 102 and the second display component 104 may alternatively be curved display components, and the auxiliary display component 103 may also be a flat display component. The embodiments of the present disclosure do not limit the first display component 102, the auxiliary display component 103, and the second display component 104 to a flat display component or a curved display component.

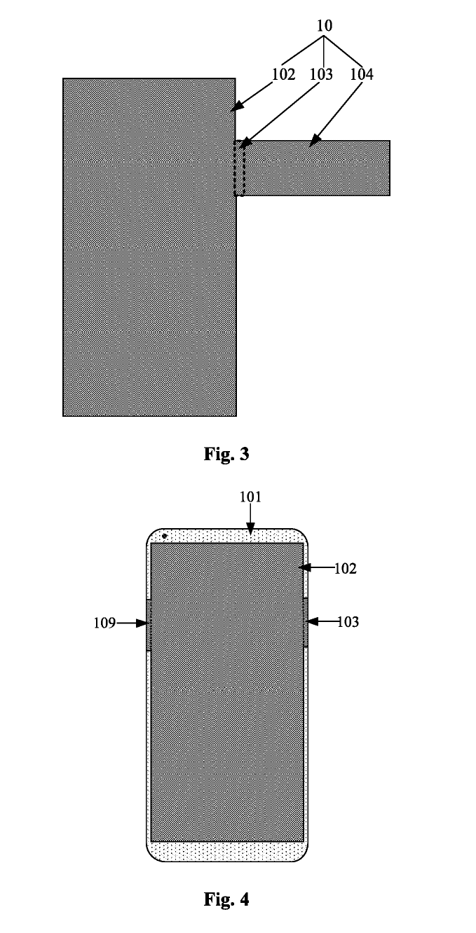

FIG. 3 is an exploded structural view of a display screen according to an embodiment of the present disclosure. It should be noted that the display screen may include the first display component 102, the auxiliary display component 103, and the second display component 104 as illustrated in FIGS. 1 and 2. As illustrated in FIG. 3, the first display component 102, the auxiliary display component 103, and the second display component 104 are connected into an integrated piece 10, and each of the first display component 102, the auxiliary display component 103, and the second display component 104 is formed of flexible material.

Since the three components are connected into an integrated piece and each is formed of flexible material, it is possible to obtain the three components by bending a large flexible display screen, thereby increasing manufacturing efficiency of the display device. For example, while manufacturing the first display component, the auxiliary display component and the second display component, the flexible display screen having the shape as illustrated in FIG. 3, which is an irregular display screen, may be manufactured firstly and then bending the flexible display screen to obtain the three components.

Further, referring to FIGS. 1, 2 and 3, the display area of the first display component 102 may be larger than the display area of the second display component 104. In practical applications, the display area of the first display component 102 may alternatively be less than or equal to the display area of the second display component 104, which is not limited in this embodiment of the disclosure.

Optionally, at least one of the first display component 102, the auxiliary display component 103, and the second display component 104 may have a touch function. In the present embodiment, in the case where the auxiliary display component 103 has a touch function, the auxiliary display component 103 may display a virtual switch button or a virtual volume button. The user may touch the virtual switch button on the auxiliary display component 103 to switch on or off the display screen. The user may also touch the virtual volume button displayed on the auxiliary display component to achieve the purpose of adjusting the volume. In addition, it is possible to avoid forming openings at the edge of the casing of the display device due to the need of the physical switch button or the physical volume button, thereby improving the manufacturing yield of the housing of the display device.

Optionally, at least one of the first display component 102, the auxiliary display component 103, and the second display component 104 has a fingerprint recognition function. It should be noted that the display component having a fingerprint recognition function may be a fingerprint recognition display screen, or the display component having a fingerprint recognition function may be a display screen provided with a fingerprint recognition sensor on the display side thereof. When the display component having the fingerprint recognition function is a fingerprint recognition display screen, it is possible to avoid forming openings on the cover of the display device due to the need of the fingerprint recognition component, so that the manufacturing yield of the cover of the display device can be improved.

Further, in the case where the second display component 104 has a fingerprint recognition function, the display area of the second display component 104 may coincide with the fingerprint recognition area, so that when unlocking the device with fingerprint, the user is only required to touch any area in the display area of the second display component 104 with a finger. Accordingly, the user may find the area for fingerprint recognition in the display device more quickly, thereby improving the efficiency of fingerprint unlocking.

Optionally, the display device may further include: a first cover (not illustrated in FIG. 1, FIG. 2 or FIG. 3) that may cover the first display component 102 and the auxiliary display component 103 and a second cover (not illustrated in FIG. 1, FIG. 2 or FIG. 3) that may cover the second display component 104. For example, if the first display component is a flat display component, the auxiliary display component is a curved display component, and the second display component is a flat display component, then the first cover may include a planar portion and a curved portion connected to each other, and the second cover may be a planar cover. In practical applications, the first cover may alternatively cover the first display component 102, while the second cover may alternatively cover the second display component 104 and the auxiliary display component 103. The first cover may be a flat cover, and the second cover may include a planar portion and curved portion connected to each other, which is not limited in this embodiment of the disclosure.

In the case where the first cover covers the first display component 102 and the auxiliary display component 103, the connection between the first cover and the second cover is located at the transition of the auxiliary display component 103 and the second display component 104. Therefore, when the user is at the display side of the first display component 102, the user will not see a connection gap at the transition of the first display component 102 and the auxiliary display component 103, and the display effect of the display device is improved. In addition, when manufacturing the cover by partitioning it, it is also possible to increase the manufacturing yield of the cover and facilitate mass production.

Referring further to FIGS. 1 and 2, the display device may further include: a first image capturing component 105, a second image capturing component 106, and a face recognition component (not shown in FIG. 1 or FIG. 2), and the first image capturing component 105 and the second image capturing component 106 are connected to the face recognition component. The first image capturing component 105 may be disposed adjacent to the first display component 102, the second image capturing component 106 may be disposed adjacent to the second display component 104, and an image capturing side of the first image capturing component 105 may be a display side of the first display component, and an image capturing side of the second image capturing component 106 may be a display side of the second display component.

It should be noted that the face recognition component in the display device may be a separate face recognition chip, or may be a central processing unit with a face recognition function, which is not limited in this embodiment of the disclosure. The first image capturing component 105 and the second image capturing component 106 may be two-dimensional image capturing components or three-dimensional image capturing components, which are not limited in this embodiment of the disclosure.

Optionally, the display device may further include a fill light 107 disposed adjacent to the second display component 104, and a light emitting side of the fill light 107 may be a display side of the second display component 104.

In addition, the display device may further include: a rear camera 108 disposed adjacent to the second display component 104 and a front camera (not illustrated in FIG. 1) disposed adjacent to the first display component 102. An image capturing side of the rear camera 108 may be a display side of the second display component 104, and an image capturing side of the front camera may be a display side of the first display component 102.

It should be noted that, the front camera may be integrated with the first image capturing component as one component, and the rear camera may be integrated with the second image capturing component as one component. In the embodiment of the disclosure, the example is that the front camera is integrated in the first image capturing component, and the rear camera and the second image capturing component are mutually independent, which is not limited in this embodiment of the present disclosure.

When the user needs to take a selfie, the user may be at the display side of the second display component 104 and use the rear camera 108 to take a selfie. In this case, the second display component 104 may display the face image captured by the rear camera 108. Moreover, the user may also turn on the fill light 107 to fill the light, which improves the photographing performance of the display device. Generally, the resolution of the rear camera is higher than that of the front camera, thus improving the photographing effect of the display device.

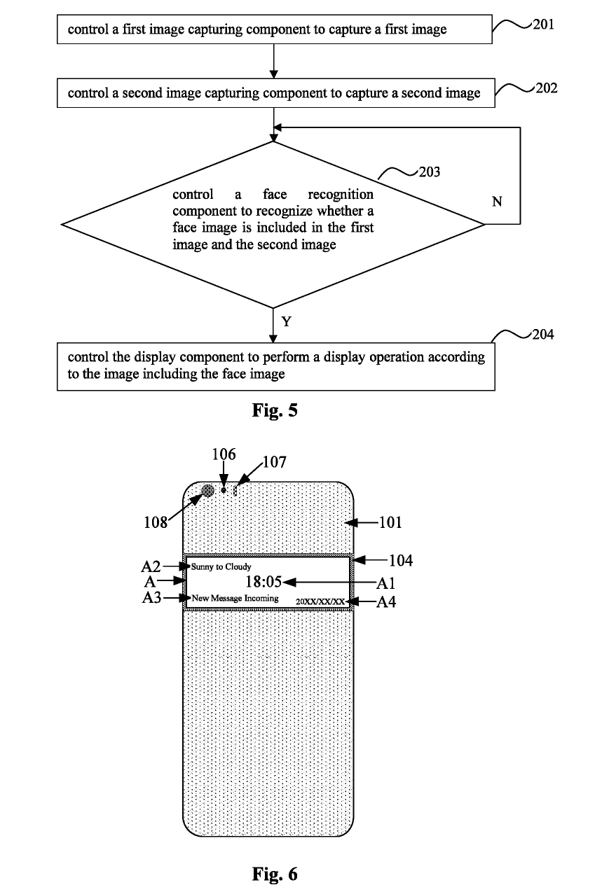

In addition, a third display component may be disposed on the housing 101 of the display device as illustrated in FIGS. 1 and 2. For example, FIG. 4 is a front view of another display device according to an embodiment of the present disclosure. As illustrated in FIG. 4, on the basis of FIG. 1, the third display component 109 is further disposed on the housing 101 of the display device. The third display component 109 is connected to the first display component 102 and is disposed opposite to the auxiliary display component 103. Since the third display component 109 may be further disposed on the housing of the display device, and the third display component 109 is connected to the second display component 102 and is disposed opposite to the auxiliary display component 103, then the display device has display regions on the front side, the rear side and both the side edges, which further increases the display area of the display device.

In summary, in the display device provided by the embodiment of the present disclosure, the first display component, the auxiliary display component, and the second display component that are connected in sequence are disposed on the housing of the display device, and the first display component and the second display component are disposed oppositely on the housing, and thus the display device has display regions on the front side, the rear side and a side edge, which increases the display area of the display device.

An embodiment of the present disclosure further provides a method for controlling a display device applicable to a control device of the display device as illustrated in FIG. 1 or FIG. 2. The method for controlling the display device may include: controlling at least one display component of the first display component, the auxiliary display component and the second display component to perform a display operation.

For example, FIG. 5 is a method flowchart of a method for controlling a display device according to an embodiment of the present disclosure. As illustrated in FIG. 5, the controlling at least one display component of the first display component, the auxiliary display component and the second display component to perform a display operation may particularly include the following steps.

In step 201, a first image capturing component is controlled to capture a first image.

In step 202, a second image capturing component is controlled to capture a second image.

It should be noted that the first image capturing component and the second image capturing component may be two-dimensional image capturing components or three-dimensional image capturing components. For example, in the case where both the first image capturing component and the second image capturing component are two-dimensional image capturing components, the first image and the second image are both two-dimensional images, for example, two-dimensional face images. In the case where both the first image capturing component and the second image capturing component are three-dimensional image capturing components, the first image and the second image are both three-dimensional images, for example, three-dimensional face images.

For example, the two-dimensional image capturing component may be a visible light imaging component, and the three-dimensional image capturing component may be an IR imaging component or an ultrasonic imaging component.

In step 203, a face recognition component is controlled to recognize whether a face image is included in the first image and the second image.

For example, the face recognition component extracts a feature from the first image after the first image capturing component captures the first image, judges whether a similarity between the feature and a feature of a human face reaches a preset similarity threshold, and determines that a face image is included in the first image if the similarity reaches the preset similarity threshold while determines that no face image is included in the first image if the similarity does not reach the preset similarity threshold.

Similarly, the face recognition component extracts a feature from the second image after the second image capturing component captures the second image, judges whether a similarity between the feature and a feature of a human face reaches a preset similarity threshold, and determines that a face image is included in the second image if the similarity reaches the preset similarity threshold while determines that no face image is included in the second image if the similarity does not reach the preset similarity threshold.

In step 204, the display component is controlled to perform a display operation according to the image including the face image.

For example, when the first image includes a face image, the control device of the display device may control the first display component to perform the display operation. When the second image includes a face image, the control device of the display device may control the second display component to perform the display operation. When both the first and second images include face images, the control device of the display device may control both the first and second display components to perform the display operation.

It should be noted that, the display operation performed by the first display component under the control of the control device of the display device is a first display operation, and the display operation performed by the second display component under the control of the control device of the display device is a second display operation. The first display operation may be the same as the second display operation, or the first display operation is different from the second display operation, which are not limited in this embodiment of the disclosure.

For example, FIG. 6 is an interface displayed on a second display component according to an embodiment of the present disclosure. As illustrated in FIG. 6, the interface A displayed on the second display component 104 may include: time information in the middle region A1 of the interface A, weather information in the upper left region A2 of the interface A, message alert information in the lower left region A3 of the interface A, and date information in the lower right region A4 of the interface A. In the present embodiment, the time information may be in form of “18:05”, the weather information may be in form of “Sunny to Cloudy”, the message alert information may be in form of “New Message Incoming”, and the date information may be in form of “20XX/XX/XX”. In the present embodiment, X may represent any integer, and the plurality of Xs illustrated in FIG. 5 may be different integers.

In summary, in the method for controlling the display device according to the embodiment of the present disclosure, the display device may control the first display component or the second display component to perform the display operation according to the position of the user, which may improve the display performance of the display device. In addition, in the case where the second display component has a display area smaller than that of the first display component, the area of the display region may be smaller when the second display component is controlled to perform the display operation, which may reduce the power consumption of the display device.

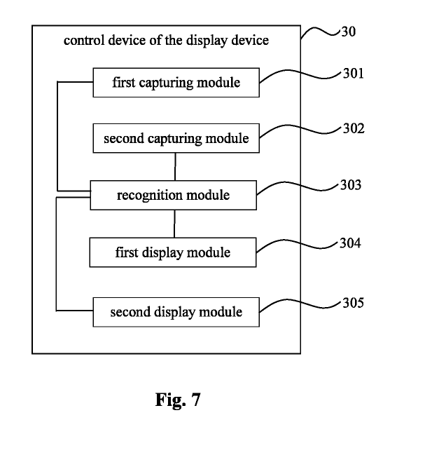

FIG. 7 is a structural view of a control device of a display device applicable to the display device as illustrated in FIG. 1 or FIG. 2, according to an embodiment of the present disclosure. As illustrated in FIG. 7, the control device 30 of the display device may include:

a first capturing module 301, configured to control a first image capturing component to capture a first image;

a second capturing module 302, configured to control a second image capturing component to capture a second image;

a recognition module 303, configured to recognize whether a face image is included in the first image and the second image;

a first display module 304, configured to control a first display component to perform a display operation in the case where the first image includes the face image; and

a second display module 305, configured to control a second display component to perform a display operation in the case where the second image includes the face image.

In summary, in the control device of the display device according to the embodiment of the present disclosure, the recognition module may recognize a position of the user, and the first display module may control the first display component to perform a display operation according to the recognition result of the recognition module, and the second display module may also control the second display component to perform a display operation according to the recognition result of the recognition module, thereby improve the display performance of the display device. In addition, in the case where the second display component has a display region of an area smaller than that of display region of the first display component, the area of the display region is smaller when the second display component is controlled to perform the display operation, which may reduce the power consumption of the display device.

It should be noted that, the method embodiments provided by the embodiments of the present disclosure may be mutually referenced with the corresponding device embodiments, and the embodiment of the present disclosure is not limited thereto. The order of the steps of the method embodiments provided in the embodiments of the present disclosure may be adjusted appropriately, and the steps may also be correspondingly added or removed according to situations. Any variated method easily conceivable to those skilled in the art within the technical scope of the present disclosure shall be included in the protection scope of the present disclosure, and therefore will not be described again.

Those skilled in the art will readily conceive other embodiments of the present disclosure upon consideration of the specification and practice of the disclosure disclosed herein. This application is intended to cover any variations, uses, or adaptations of the present disclosure which follow the general principles of the present disclosure and include any common knowledge or conventional techniques in this technical field not disclosed by the present disclosure. The description and examples are to be considered exemplary only, with the true scope and spirit of the disclosure being indicated by the claims.

It should be understood that the present disclosure is not limited to the particular structure that has been described above and shown in the drawings, and various modifications and changes may be made without departing from the scope thereof. The scope of the present disclosure is limited only by the attached claims.

1. A display device comprising a housing,
wherein the housing is provided thereon with a first display component, an auxiliary display component and a second display component that are connected in sequence, and the first display component and the second display component are oppositely disposed,
wherein the first display component, the auxiliary display component, and the second display component are embedded into the housing,
wherein the first display component, the auxiliary display component, and the second display component are a planar display component or a curved display component,
wherein the display device further includes a first cover covering the first display component and the auxiliary display component and a second cover covering the second display component,
wherein a connection between the first cover and the second cover is located at a transition of the auxiliary display component and the second display component,
wherein the display device further comprises a first image capturing component, a second image capturing component and a face recognition component, wherein the first image capturing component and the second image capturing component are both connected to the face recognition component,
wherein the first image capturing component is disposed adjacent to the first display component, the second image capturing component is disposed adjacent to the second display component, and an image capturing side of the first image capturing component is a display side of the first display component, and an image capturing side of the second image capturing component is a display side of the second display component, and
wherein the display device is configured to display through the first display component in the case where the first image includes a face image, and display through the second display component in the case where the second image includes a face image.

2. The display device according to claim 1, wherein the first display component, the auxiliary display component, and the second display component are connected into an integrated piece.

3. The display device according to claim 2, wherein each of the first display component, the auxiliary display component, and the second display component is formed of flexible material.

4-5. (canceled)

6. The display device according to claim 1, wherein a display area of the first display component is greater than a display area of the second display component.

7. The display device according to claim 1, wherein at least one of the first display component, the auxiliary display component, and the second display component has a touch function.

8. The display device according to claim 7, wherein the auxiliary display component is configured to display a virtual switch button or a virtual volume button.

9. The display device according to claim 1, wherein at least one of the first display component, the auxiliary display component, and the second display component has a fingerprint recognition function.

10. The display device according to claim 9, wherein the display component having the fingerprint recognition function is a display screen provided with a fingerprint recognition sensor disposed on a display side thereof.

11. The display device according to claim 10, wherein a display area of the display component having the fingerprint recognition function coincides with a fingerprint recognition area thereof.

12. The display device according to claim 9, wherein a display area of the display component having the fingerprint recognition function coincides with a fingerprint recognition area thereof.

13-15. (canceled)

16. The display device according to claim 1, wherein the display device further comprises a fill light disposed adjacent to the second display component, and
a light emitting side of the fill light is the display side of the second display component.

17. The display device according to claim 1, further comprising a front camera disposed adjacent to the first display component, wherein an image capturing side of the front camera is the display side of the first display component.

18. The display device according to claim 17, further comprising a rear camera disposed adjacent to the second display component, wherein an image capturing side of the rear camera is the display side of the second display component.

19. A method for controlling a display device comprising a housing, wherein the housing is provided thereon with a first display component, an auxiliary display component and a second display component that are connected in sequence, and the first display component and the second display component are oppositely disposed, the method comprising:
controlling at least one of the first display component, the auxiliary display component, and the second display component to perform a display operation,
wherein the display device further comprising a first image capturing component, a second image capturing component and a face recognition component, both of the first image capturing component and the second image capturing component are connected to the face recognition component, the first image capturing component is disposed adjacent to the first display component, the second image capturing component is disposed adjacent to the second display component, an image capturing side of the first image capturing component is a display side of the first display component, and an image capturing side of the second image capturing component is a display side of the second display component,
wherein the controlling at least one of the first display component, the auxiliary display component, and the second display component to perform a display operation comprises:
capturing a first image using the first image capturing component
capturing a second image using the second image capturing component
recognizing whether a face image is included in the first image and the second image using the face recognition component
controlling the first display component to perform a display operation in the case where the first image includes a face image; and
controlling the second display component to perform a display operation in the case where the second image includes a face image.

20. (canceled)
